(19) United States
(12) Patent Application Publication
(10) Pub. No.: US 2007/0226085 A1
(43) Pub. Date: Sep. 27, 2007

(54) System and method for automated mapping of data in a multi-valued data structure

(76) Inventors: James A. Roach, Southlake, TX (US); Lisa Roach, Southlake, TX (US)

Correspondence Address: BAKER BOTTS L.L.P., 2001 ROSS AVENUE, SUITE 600, DALLAS, TX, 75201-2980, US

(21) Appl. No.: 11/372,884

(22) Filed: Mar. 10, 2006

(51) Int. Cl. G06Q 10/00

(52) U.S. Cl. 705/28

(57) ABSTRACT

A method for managing a database comprises receiving a data record comprising a plurality of interface labels. The method continues by identifying in the data record a particular interface label and an associated label position. The method continues by storing the identified interface label and the associated label position in a first file. The method continues by scanning from the first file a particular interface label. The method continues by determining a mapping label that corresponds to the scanned interface label. The method continues by associating in a second file the determined mapping label with the scanned interface label. The method continues by identifying a test value associated with the determined mapping label. The method concludes by inputting the test value into the data record, wherein the test value is input according to the identified label position.

### TECHNICAL FIELD OF THE INVENTION

This invention relates generally to electronic databases and more specifically to a system and method for automated mapping of data in a multi-valued data structure.

### BACKGROUND OF THE INVENTION

Database systems are widely used for storing, managing, and organizing data. Clients often extract and use data from database systems of multiple enterprises. A common challenge to clients is the lack of uniformity in how different enterprises organize their databases. Different enterprises, even enterprises engaged in similar businesses, often store a particular type of data differently. As a result, when a client receives data records from different database systems, the client must search in different portions of the data records to identify the same type of data. Such searching is often time consuming and inefficient.

### SUMMARY OF THE INVENTION

In accordance with the present invention, the disadvantages and problems associated with traditional reorganization of a database have been substantially reduced or eliminated.

A method for managing a database comprises receiving a data record comprising a plurality of interface labels. The method continues by identifying in the data record a particular interface label and an associated label position. The method continues by storing the identified interface label and the associated label position in a first file. The method continues by scanning from the first file a particular interface label. The method continues by determining a mapping label that corresponds to the scanned interface label. The method continues by associating in a second file the determined mapping label with the scanned interface label. The method continues by identifying a test value associated with the determined mapping label. The method concludes by inputting the test value into the data record, wherein the test value is input according to the identified label position.

The invention has several important technical advantages. Various embodiments of the invention may have none, some, or all of these advantages. One advantage is that the present invention may enable a database system to generate a field map for each type of database in the database system. The field maps may allow clients to extract data from multiple databases that have different data storage conventions. Another advantage is that the present invention may enable a database system to generate an alias file for each type of database in the database system. Alias files may correlate interface labels with mapping labels used for mapping databases. A database system may use alias files to generate field maps automatically. By generating field maps for databases, the present invention may reduce the time and/or resources required to extract data from multiple databases having different data storage conventions.

Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description taken in conjunction with the accompanying drawings in which:

FIG. 1 illustrates a database system according to certain embodiments of the present invention;

FIGS. 2A-2C illustrate a test file, a retrieved data record, and a field map according to certain embodiments of the present invention;

FIGS. 3A-3B illustrate a flowchart for generating a field map according to certain embodiments of the present invention;

FIGS. 4A-4E illustrate a test file, screen files, and alias files according to certain embodiments of the present invention;

FIG. 5 illustrates an example screen from a user interface according to certain embodiments of the present invention; and

FIG. 6 illustrates a flowchart for generating an alias file according to certain embodiments of the present invention.

### DETAILED DESCRIPTION OF THE DRAWINGS

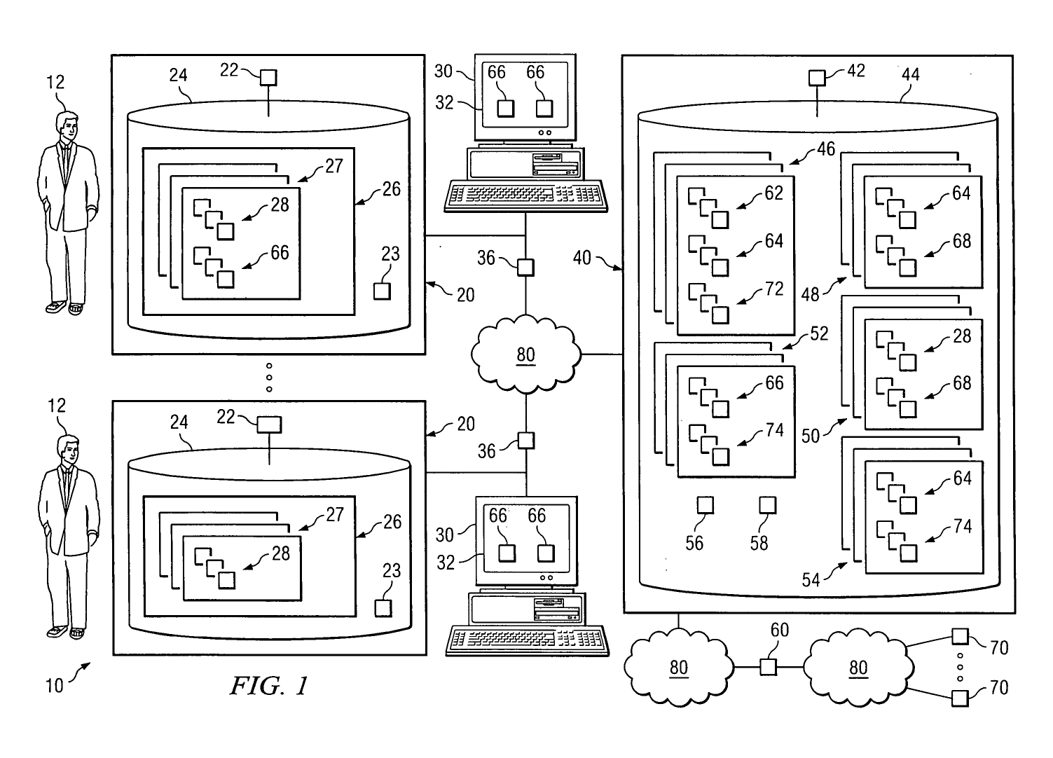

FIG. 1 illustrates database system 10 according to certain embodiments of the present invention. Database system 10 is operable to extract data values 28 from and input data values 28 into multiple types of databases 26. Database system 10 may comprise enterprise server 20, console 30, security module 36, mapping server 40, interface module 60, and clients 70. The foregoing components of database system 10 may be communicatively coupled via network 80. Generally, database system 10 is operable to receive and store data values 28; receive and respond to requests for data values 28; maintain and organize databases 26; and transmit data values 28 from databases 26 to clients 70 and/or other entities.

Database system 10 may comprise a plurality of enterprise servers 20. Each enterprise server 20 may be associated with an enterprise 12 such as, for example, a business, company, organization, office, individual, and/or any suitable entity. Different types of enterprises 12 may be associated with enterprise servers 20 in database system 10. It should be understood that a particular enterprise 12 may be associated with any suitable number and combination of enterprise servers 20.

Enterprise server 20 is generally operable to manage, store, and/or organize data values 28 associated with enterprise 12. Enterprise server 20 may comprise a general-purpose personal computer (PC), a Macintosh, a workstation, a Unix-based computer, a server computer, or any suitable processing device. Enterprise server 20 may include any hardware, software, firmware, or combination thereof operable to perform the described operations and functions. To make database system 10 more robust, enterprise server 20 may be associated with a redundant enterprise server 20 which is operable to assume substantially all of the functionality of enterprise server 20 in the event of a failure. Although FIG. 1 provides one example of enterprise server 20 that may be used with the invention, database system 10 can be implemented using computers other than servers, as well as a server pool.

Enterprise server 20 may comprise an enterprise memory 24 and an enterprise processor 22. Enterprise memory 24 may comprise one or more databases 26. Enterprise memory 24 may represent any memory device, direct access storage device (DASD), or storage module and may take the form of volatile or non-volatile memory comprising, without limitation, magnetic media, optical media, random access memory (RAM), read-only memory (ROM), removable media, or any other suitable local or remote memory component. Enterprise memory 24 may store enterprise logic 23 that, when executed, is operable to receive data values 28, manage databases 26, process queries, and transmit data values 28 to enterprise 12 and/or other modules of database system 10. Enterprise memory 24 may be communicatively coupled to enterprise processor 22. Enterprise processor 22 is operable to execute enterprise logic 23 to perform the described functions and operations.

Database 26 represents a matrix, table, compilation, and/or grouping of data records 27. In database 26, data records 27 may be organized and/or linked in any suitable fashion. In some embodiments, data record 27 may store data values 28 related to a particular transaction, deal, order, project, individual, and/or any number and combination of characteristics. Database 26 may represent a multi-value database, an online analytical processing database, an online transaction processing database, a flat-file database, a network database, a relational database, an object-oriented database, and/or any other suitable number and combination of databases and database types.

Data record 27 may comprise one or more interface labels 66. A particular interface label 66 may be associated with a particular field and/or type of data value 28. Interface label 66 may describe, denote, and/or suggest the type of data value 28 to be input into a particular data field in data record 27. For example, a particular data record 27 related to a sales transaction may comprise a data field for interest rate. The data field for interest rate may be associated with interface label 66 of “Rate”, “Interest”, “APR”, and/or any other suitable label. It should be understood that a particular data record 27 in database 26 may comprise any suitable number and combination of interface labels 66.

Enterprise server 20 may be communicatively coupled to console 30. An operator and/or administrator associated with a particular enterprise 12 may use console 30 to input and/or retrieve data values 28 from database 26 in enterprise server 20. Console 30 may represent any suitable device for transmitting and/or receiving electronic communications. Console 30 may represent a computer, work station, electronic notebook, mobile phone, handheld device, personal data assistant (PDA), pager, mini computer, or other device capable of wireless and/or wireline communications. It will be understood that there may be any number and combination of operator consoles 30 in database system 10.

Console 30 may comprise a user interface 32. Generally, user interface 32 provides an operator of console 30 with one or more displays for inputting, retrieving, and/or viewing data values 28 associated with enterprise 12. In particular, user interface 32 may provide screens on which data values 28 are displayed in association with interface labels 66. By reading a particular interface label 66 on a screen, an operator may determine a particular type of data value 28 to input into console 30. It should be understood that the term user interface may be used in the singular or in the plural to describe one or more user interfaces and each of the displays of a particular user interface.

Enterprise server 20 and/or console 30 may be communicatively coupled to security module 36. Security module 36 is generally operable to provide a secure port for communications between enterprise server 20 and/or console 30 and other components of database system 10. Security module 36 may facilitate one or more secure data streams between enterprise server 20 and/or console 30 and other components of database system 10. Security module 36 may represent a general-purpose personal computer (PC), a Macintosh, a workstation, a Unix-based computer, a server computer, or any suitable processing device. Security module 36 may include any hardware, software, firmware, or combination thereof operable to perform the above operations and functions. To make database system 10 more robust, security module 36 may be associated with a redundant security module 36 which is operable to assume substantially all of the functionality of security module 36 in the event of a failure.

Security module 36 may communicate via network 80 with mapping server 40. Mapping server 40 is generally operable to receive requests for data values 28 from clients 70; extract data values 28 from databases 26 in enterprise servers 20; input data values 28 into databases 26 in enterprise servers 20; generate field maps 48 associated with databases 26; synchronize data values 28 extracted from and/or input into databases 26; and transmit data values 28 to clients 70. Mapping server 40 may comprise a general-purpose personal computer (PC), a Macintosh, a workstation, a Unix-based computer, a server computer, or any suitable processing device. Mapping server 40 may include any hardware, software, firmware, or combination thereof operable to perform the above operations and functions. To make database system 10 more robust, mapping server 40 may be associated with a redundant mapping server 40 which is operable to assume substantially all of the functionality of mapping server 40 in the event of a failure. Although FIG. 1 provides one example of mapping server 40 that may be used with the invention, database system 10 can be implemented using computers other than servers, as well as a server pool.

Mapping server 40 comprises a mapping memory 44 and a processor 42. Mapping memory 44 comprises mapping logic 56 that, when executed, is operable to extract data values 28 from databases 26, input data values 28 into databases 26, generate field maps 48 associated with enterprise servers 20, generate alias files 54 associated with enterprise servers 20, and process requests for data values 28 from clients 70. Mapping memory 44 is communicatively coupled to processor 42. Processor 42 is operable to execute mapping logic 56 to perform the described functions and operations.

Mapping server 40 may be communicatively coupled to interface module 60 via network 80. Interface module 60 is generally operable to receive requests for data values 28 from clients 70, receive data values 28 from mapping server 40, and format data values 28 for transmission to a particular client 70. Interface module 60 may comprise a general-purpose personal computer (PC), a Macintosh, a workstation, a Unix-based computer, a server computer, or any suitable processing device. Interface module 60 may include any hardware, software, firmware, or combination thereof operable to perform the above operations and functions. Although interface module 60 is illustrated as a module separate from mapping server 40, it should be understood that all or a portion of the functions performed by interface module 60 may be performed by mapping server 40.

Interface module 60 may communicate via network 80 with one or more clients 70. Clients 70 generally request and process data values 28 from enterprise servers 20. In some embodiments, clients 70 use data values 28 from enterprise servers 20 to facilitate the provision of goods, information, and/or services to enterprises 12, customers of enterprises 12, partners of enterprises 12, and/or any number and combination of entities. Clients 70 may represent businesses, companies, systems, organizations, individuals, and/or any suitable entity.

Network 80 may represent any number and combination of wireline and/or wireless networks suitable for data transmission. Network 80 may, for example, communicate internet protocol packets, frame relay frames, asynchronous transfer mode cells, and/or other suitable information between network addresses. Network 80 may include one or more intranets, local area networks, metropolitan area networks, wide area networks, cellular networks, all or a portion of the Internet, and/or any other communication system or systems at one or more locations.

In operation, database system 10 is operable to use mapping server 40 to facilitate the extraction and/or insertion of data values 28 in databases 26 in enterprise servers 20. In some embodiments, the particular enterprise servers 20 in database system 10 may differ from one another. A particular enterprise server 20 may comprise different hardware and/or software components than another enterprise server 20 in database system 10. As a result, enterprise server 20 in database system 10 may configure data records 27 differently than another enterprise server 20. For example, for a particular data record 27 related to the sale of a car, a first enterprise server 20 may associate data value 28 for price with a first position in data record 27. However, a second enterprise server 20 may associate data value 28 for price with a sixth position in data record 27. In some embodiments, a particular enterprise server 20 may configure a particular data record 27 to store more or less types of data values 28 than another enterprise server 20. For example, for a particular data record 27 related to the sale of a car, a first enterprise server 20 may store in data record 27 data values 28 related to the color and weight of the car. A second enterprise server 20, however, may omit from data record 27 data values 28 related to color and weight. Thus, different enterprise servers 20 may configure their respective data records 27 differently. Although the foregoing examples relate to the sale of a car, it should be understood that databases 26 may store any number and types of data values 28.

The position of a particular data value 28 in data record 27 may be expressed by a position identifier 68. Position identifier 68 may be any indicator suitable for expressing the position of a particular data value 28 in data record 27. In some embodiments, data record 27 may be configured as a matrix of data values 28 and position identifiers 68 may be numerical values corresponding to places in the matrix. For example, in data record 27 for a sales transaction, data value 28 for price may be the third data value 28 in data record 27. Accordingly, data value 28 for price may be associated with position identifier 68 of “3”. Although in the foregoing example data record 27 is illustrated as a matrix of data values 28, it should be understood that data record 27 may comprise any suitable structure for storing data values 28. Although in the foregoing example, position identifier 68 is expressed as numerical value, it should be understood that position identifier 68 may be any type of indicator suitable for representing a position in data record 27, including without limitation alphanumeric characters.

Mapping server 40 is operable to extract data values 28 from databases 26 in enterprise servers 20. Mapping server 40 is further operable to insert data values 28 into databases 26 in enterprise servers 20. To facilitate extraction and/or insertion of data values 28 in different types of enterprise servers 20, mapping server 40 is operable to generate field maps 48 that correspond to databases 26 in enterprise servers 20. Generally, field map 48 corresponding to a particular enterprise server 20 may be used by processor 42 to extract data values 28 from the particular enterprise server 20. Field map 48 may correlate position identifiers 68 with types of data values 28 stored in enterprise server 20. To extract a particular data value 28 from enterprise server 20, processor 42 may use field map 48 to locate the particular data value 28 in enterprise server 20. By using field map 48, processor 42 may avoid scanning all data values 28 in data records 27 in order to identify a particular data value 28. It should be understood that processor 42 may, additionally or alternatively, use field map 48 to insert data values 28 into enterprise server 20. To insert a particular data value 28 into enterprise server 20, processor 42 may use field map 48 to locate the particular position, in enterprise server 20, corresponding to type of the particular data value 28. By using field map 48, processor 42 may avoid scanning all positions in database 26 and/or data record 27 in order to identify the position in which to insert the particular data value 28.

Field map 48 may comprise mapping labels 64 and position identifiers 68. In some embodiments, each mapping label 64 may be associated with at least one position identifier 68. Mapping labels 64 in field map 48 may correspond to interface labels 66 in data records 27. A particular mapping label 64 may thus indicate a particular type of data value 28. For example, a particular mapping label 64 may be “Price” corresponding to the sale price of a product. As another example, a particular mapping label 64 may be “Customer Name” corresponding to the name of the purchaser of a product. It will be understood that field map 48 may comprise any number and combination of mapping labels 64. In some embodiments, field maps 48 may be stored in mapping memory 44.

In field map 48, a particular mapping label 64 may be associated with a particular position identifier 68. The particular position identifier 68 may indicate where, in data record 27, the type of data value 28 corresponding to the particular mapping label 64 is stored. For example, in field map 48 mapping label 64 of “Price” may be associated with position identifier 68 of “6”. In this example, processor 42 may use field map 48 to locate data values 28 representing prices. It should be understood that a different type of enterprise server 20 may be associated with a different field map 48. For example, a different type of enterprise server 20 may store data values 28 for price in the third position in data records 27 rather than in the sixth position. Accordingly, in field map 48 for that type of enterprise server 20, mapping label 64 of “Price” may be associated with position identifier 68 of “3” instead of “6”.

Mapping server 40 is operable to substantially simultaneously use different field maps 48 in extracting data values 28 from different types of enterprise servers 20. For example, client 70 may request to extract price data from a first enterprise server 20 and a second enterprise server 20. Using the respective field maps 48 for the first and second enterprise servers 20, processor 42 may determine that price data is stored in a first position in data records 27 in the first enterprise server 20 and in a second position in data records 27 in the second enterprise server 20. Processor 42 may directly proceed to the first position of data records 27 in the first enterprise server 20 to extract the desired data values 28. Substantially simultaneously, processor 42 may directly proceed to the second position of data records 27 in the second enterprise server 20 to extract the desired data values 28. Thus, processor 42 may extract data values 28 from enterprise servers 20 using the respective field maps 48 for each enterprise servers 20.

Mapping server 40 may generate and use test file 46 to generate field map 48. Test file 46 may be stored in mapping memory 44. Test file 46 generally comprises mapping labels 64 and test values 62. Each mapping label 64 in test file 46 may be associated with a particular test value 62 and a particular expected position identifier 72. Test value 62 may be any configurable and/or arbitrary value. For example, “LAST” may be test value 62 associated with mapping label 64 of “Customer Last Name”. As another example, “10,001.01” may be test value 62 associated with mapping label 64 of “Price”. It will be understood that test values 62 may represent any number and combination of values suitable for mapping data records 27.

To generate field map 48 for a particular enterprise server 20, processor 42 creates a new data record 27 in enterprise memory 24 in enterprise server 20. In some embodiments, processor 42 may create the new data record 27 by communicating with console 30 and/or user interface 32 associated with enterprise server 20. The new data record 27 may comprise a plurality of interface labels 66 associated with empty data fields. Processor 42 may use test file 46 to populate the data fields of the new data record 27. In particular, processor 42 may identify the first interface label 66 of data record 27. Processor 42 may then scan test file 46 to identify a particular mapping label 64 that corresponds to the first interface label 66. Upon identifying a corresponding mapping label 64 in test file 46, processor 42 may read in test file 46 the particular test value 62 associated with the identified mapping label 64. Processor 42 may then input the particular test value 62 into the data field associated with the first interface label 66. Processor 42 may then read the next interface label 66 of data record 27. Processor 42 may repeat this process until all test values 62 of test file 46 have been input into the new data record 27. Alternatively, or in addition, the various test values 62 may be input into the new data record 27 manually by an operator of mapping server 40 and/or console 30. Processor 42 may then transmit the new data record 27 to enterprise server 20. Enterprise server 20 may process and store the new data record 27 in database 26 in enterprise memory 24. In storing the new data record 27, enterprise server 20 will associate each data value 28 of new data record 27 with a particular position in database 26.

Once the new data record 27 is stored in enterprise server 20, processor 42 may command enterprise server 20 to recall the new data record 27. The recalled new data record 27 may be referred to as retrieved data record 50. Retrieved data record 50 may comprise interface labels 66 with corresponding data values 28 and position identifiers 68. At least a portion of data values 28 in retrieved data record 50 are test values 62 that were input by processor 42 and/or manually by an operator. Position identifier 68 for a particular data value 28 represents the position of that data value 28 in retrieved data record 50. Position identifiers 68 in retrieved data record 50 may have been determined by enterprise server 20 and/or processor 42 in recalling the new data record 27. Processor 42 may store retrieved data record 50 in mapping memory 44.

Processor 42 may use retrieved data record 50 and test file 46 to generate field map 48 for enterprise server 20. In particular, processor 42 may read the first mapping label 64 and the first test value 62 (i.e., test value 62 corresponding to the first mapping label) in test file 46. Processor 42 may then scan data values 28 in retrieved data record 50 to identify a particular data value 28 that matches the first test value 62. Upon identifying a matching data value 28, processor 42 may identify the particular position identifier 68 that corresponds to the matching data value 28. Processor 42 may then associate the first mapping label 64 with the identified position identifier 68. Processor 42 may store the first mapping label 64 in association with the identified position identifier 68 in field map 48. Processor 42 may then read the second mapping label 64 and associated test value 62 in test file 46. Processor 42 may repeat the foregoing process until each mapping label 64 from test file 46 has been associated with a particular position identifier 68 from retrieved data record 50. Processor 42 may store field map 48 in mapping memory 44.

In some embodiments, test file 46 may further comprise expected position identifiers 72. Each mapping label 64 in test file 46 may be associated with a particular expected position identifier 72. Expected position identifier 72 may indicate to processor 42 where, in retrieved data record 50, processor 42 should begin scanning to identify a particular data value 28 that matches a particular test value 62. Processor 42 may determine expected position identifiers 72 in test file 46 based at least in part on the type of enterprise server 20.

Processor 42 is operable to generate multiple field maps 48. In particular, processor 42 may generate a particular field map 48 for each type of enterprise server 20 in database system 10. In some embodiments, processor 42 may use the same test file 46 in generating field maps 48 for each type of enterprise server 20.

It should be understood that processor 42 may communicate with enterprise server 20 and/or console 30 to input into and retrieve from database 26 the new data record 27.

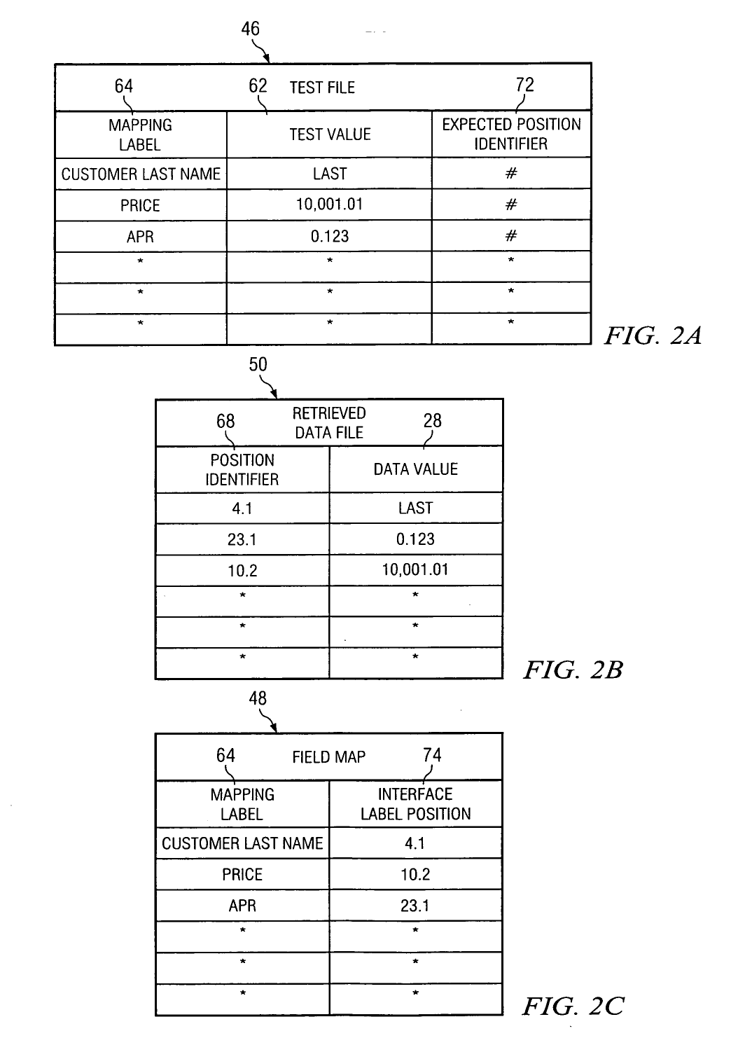

FIG. 2 illustrates a test file 46, retrieved data record 50, and field map 48 according to certain embodiments of the present invention. Database system 10 is generally operable to generate field map 48 associated with a particular enterprise server 20. To generate field map 48, mapping server 40 may generate and use test file 46. Referring to FIG. 2A, test file 46 may comprise a plurality of mapping labels 64 and test values 62. Each mapping label 64 in test file 46 may be associated with a test value 62. For example, a particular test file 46 may comprise mapping label 64 of “Customer Last Name” associated with test value 62 of “LAST”; mapping label 64 of “Price” associated with test value 62 of “10,001.01”; mapping label 64 of “Annual Percentage Rate (APR)” associated with “0.123”; and so forth. It will be understood that there may be any number and combination of mapping labels 64 and corresponding test values 62 in test file 46. Processor 42 may store test file 46 in mapping memory 44.

In some embodiments, test file 46 may further comprise expected position identifiers 72. In generating test file 46, processor 42 may determine the type of the particular enterprise server 20. Based at least in part on this determination, processor 42 may predict the positions in database 26 where enterprise server 20 will likely store particular types of data values 28. Processor 42 may represent the predicted positions with expected position identifiers 72. For each mapping label 64 in test file 46, processor 42 may determine and store in test file 46 an expected position identifier 72.

After generating and/or retrieving test file 46, processor 42 may command enterprise server 20 to open and/or generate a new data record 27. Processor 42 may use test file 46 to populate the data fields in the new data record 27. In particular, processor 42 may read the first interface label 66 in the new data record 27. Processor 42 may then identify in test file 46 the particular mapping label 64 that corresponds to the first interface label 66. Processor 42 may read from test file 46 the particular test value 62 associated with the identified mapping label 64. Processor 42 may then input the particular test value 62 into the data field associated with the first interface label 66 in the new data record 27. Processor 42 may then read the next interface label 66 in the new data record 27. Processor 42 may repeat the foregoing process until all test values 62 have been input into the new data record 27. If there is no mapping label 64 in test file 46 that corresponds to a particular interface label 66, processor 42 may leave the corresponding data field blank. In some embodiments, the inputting of test values 62 into the new data record 27 may be performed manually by an operator.

Once test values 62 have been input into the new data record 27, enterprise server 20 may store the new data record 27 in database 26. When the new data record 27 is stored in a particular enterprise server 20, data values 28 in the new data record 27 may be stored in various positions in database 26 according to the formatting and/or data storage conventions associated with the particular enterprise server 20. For example, a particular enterprise server 20 may be configured to store a particular type of data value 28 in a particular position in database 26.

Once enterprise server 20 stores the new data record 27 in database 26, processor 42 may direct enterprise server 20 to retrieve the new data record 27 from database 26. In some embodiments, enterprise server 20 and/or processor 42 may assign a file identifier to the new data record 27. The new data record 27 may be stored in and retrieved from database 26 according to the file identifier. Once retrieved from database 26, the new data record 27 may be referred to as retrieved data record 50. Referring to FIG. 2B, retrieved data record 50 may comprise data values 28 and corresponding position identifiers 68.

Generally, processor 42 may generate field map 48 based on test file 46 and retrieved data record 50. An example field map 48 is illustrated in FIG. 2C. In particular, processor 42 may read from test file 46 the first mapping label 64, the first test value 62 (i.e., test value 62 corresponding to the first mapping label), and the first expected position identifier 72 (i.e., expected position identifier 72 corresponding to the first mapping label). In some embodiments, retrieved data record 50 may be sorted according to position identifiers 68. Processor 42 may therefore proceed to the particular position identifier 68 in retrieved data record 50 that corresponds to the first expected position identifier 72. Processor 42 may then compare the data value 28 associated with the particular position identifier 68 in retrieved data record 50 with the first test value 62. If the particular data value 28 matches the first test value 62, then processor 42 may store the first mapping label 64 in field map 48 in association with the particular position identifier 68.

If, however, the particular data value 28 does not match the first test value 62, then processor 42 may generate an alert. Processor 42 may then scan retrieved data record 50 to identify a particular data value 28 that matches the first test data value 28. Upon identifying a matching data value 28, processor 42 may identify the particular position identifier 68 that corresponds to the matching data value 28. Processor 42 may then associate the first mapping label 64 with the identified position identifier 68. Processor 42 may store the first mapping label 64 in association with the identified position identifier 68 in field map 48. Processor 42 may then read the second mapping label 64 and associated test value 62 in test file 46. Processor 42 may repeat the foregoing process until each mapping label 64 from test file 46 has been associated with a particular position identifier 68 from retrieved data record 50.

An example illustrates certain embodiments of the present invention. In the present example, a particular client 70 wishes to extract data values 28 from enterprise servers 20 of two different car dealerships—a first dealership and a second dealership. Enterprise servers 20 associated with these two car dealerships store data values 28 differently. In other words, the particular data values 28 may be stored in different positions of different data records 27. Accordingly, processor 42 generates and/or retrieves test file 46. In the present example, test file 46 comprises mapping label 64 of “Customer Last Name” associated with test value 62 of “LAST” and mapping label 64 of “Price” associated with test value 62 of “10,001.01”. Processor 42 then directs enterprise server 20 associated with the first dealership to open a new data record 27. Processor 42 receives the new data record 27 and reads the first interface label 66 in the new data record 27. In the present example, the first interface label 66 is “Price”. Accordingly, processor 42 scans test file 46 to identify the corresponding mapping label 64 and associated test value 62. Processor 42 then inputs into the new data record 27 the particular test value 62—“10,001.01”. Processor 42 then reads the second interface label 66. In the present example, the second interface label 66 is “Customer Last Name”. Processor 42 then scans test file 46 to identify the corresponding mapping label 64 and associated test value 62. Processor 42 then inputs into the new data record 27 the particular test value 62—“LAST”. In some embodiments, the foregoing process of inputting test values 62 into the new data record 27 may be performed manually by an operator.

Once test values 62 have been input into the new data record 27, enterprise server 20 associated with the first dealership stores the new data record 27 in database 26. In the present example, database 26 associated with the first dealership is configured to store price data in position “10.2” and to store a customer's last name in position “4.1”.

Processor 42 repeats the foregoing procedure with regards to the second dealership. Once test values 62 have been input into the new data record 27 for the second dealership, enterprise server 20 associated with the second dealership stores the new data record 27 in database 26. In the present example, database 26 associated with the second dealership is configured to store price data in position “5.1” and to store a customer's last name in position “6.1”. Processor 42 subsequently directs enterprise servers 20 associated with the first and second dealerships to retrieve the new data records 27 from the respective databases 26. Retrieved data records 50 comprise data values 28 and corresponding position identifiers 68.

Processor 42 uses retrieved data records 50 and test files 46 to generate field maps 48 associated with the respective dealerships. As a result, in field map 48 associated with the first dealership, processor 42 stores “Price” in association with position “10.2” and “Customer Last Name” in association with position “4.1”. In field map 48 associated with the second dealership, processor 42 stores “Price” in association with position “5.1” and “Customer Last Name” in association with position “6.1”. Once mapping server 40 creates field maps 48 associated with the first and second dealerships, database system 10 uses field maps 48 to extract data values 28 from the respective enterprise servers 20.

In some embodiments, if client 70 wishes to extract particular data values 28 from a particular enterprise server 20 after field map 48 has been created for that enterprise server 20, then mapping module 40 does not need to create a new field map 28 to extract the particular data values 28. Mapping server 40 may use the existing field map 48 to extract data values 28 from enterprise server 20 and to provide an on-demand response to client 70. Thus, in the foregoing example, if client 70 requests a second extraction of data values 28 from the first and/or second car dealerships, mapping server 40 may use the existing field maps 48 to extract data values 28 and to respond to the request of client 70.

In the foregoing example, databases 26 are associated with car dealerships. It should be understood, however, that databases 26 in database system 10 may be associated with any suitable entities. It should be further understood that database system 10 may comprise any number and combination of enterprise servers 20 and databases 26.

It should be understood that, in some embodiments, mapping server 40 may use field map 48 to insert data values 28 into enterprise server 20. To insert a particular data value 28 into enterprise server 20, processor 42 may use field map 48 to locate the particular position, in enterprise server 20, corresponding to type of the particular data value 28. Processor 42 may thereby avoid scanning all positions in database 26 and/or data record 27 to identify the position in which to insert the particular data value 28.

Database system 10 may provide important technical advantages. Various embodiments of database system 10 may have none, some, or all of these advantages. One advantage is that database system 10 is operable to generate a particular field map 48 for each type of enterprise server 20 in database system 10. Database system 10 may use field maps 48 to efficiently locate and/or extract data values 28 from enterprise servers 20. Because field maps 48 identify where particular types of data values 28 are stored in databases 26, database system 10 may extract a desired type of data value 28 from databases 26 without scanning each data field of data records 27. Thus, database system 10 saves time and processing resources.

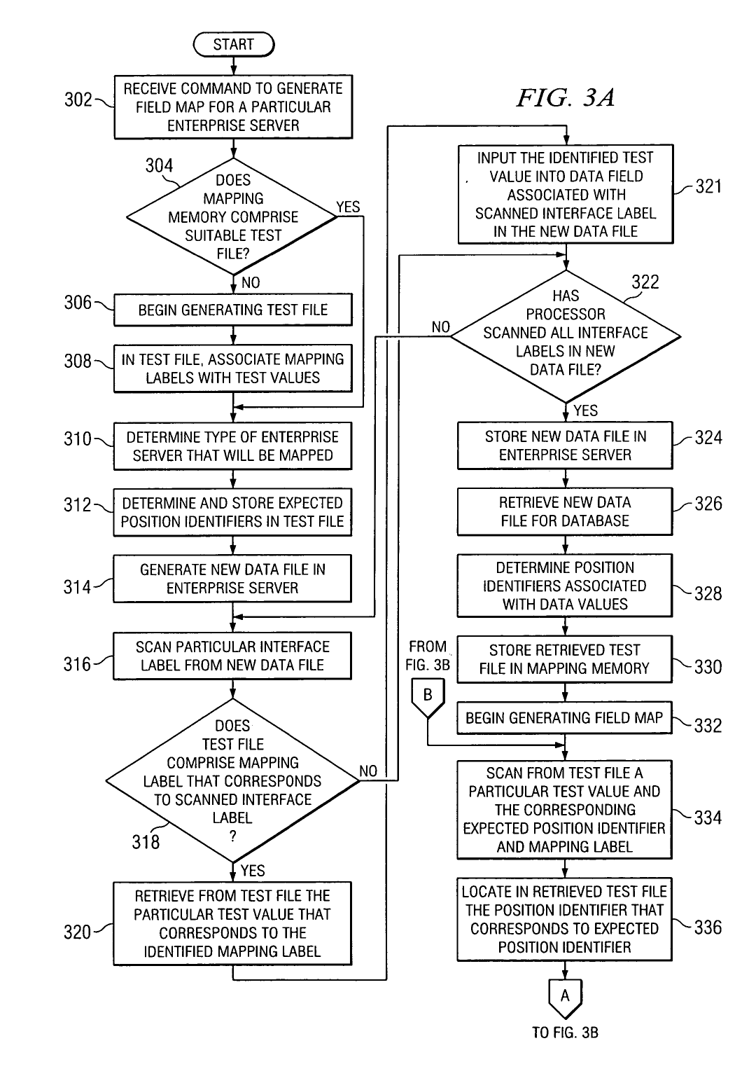

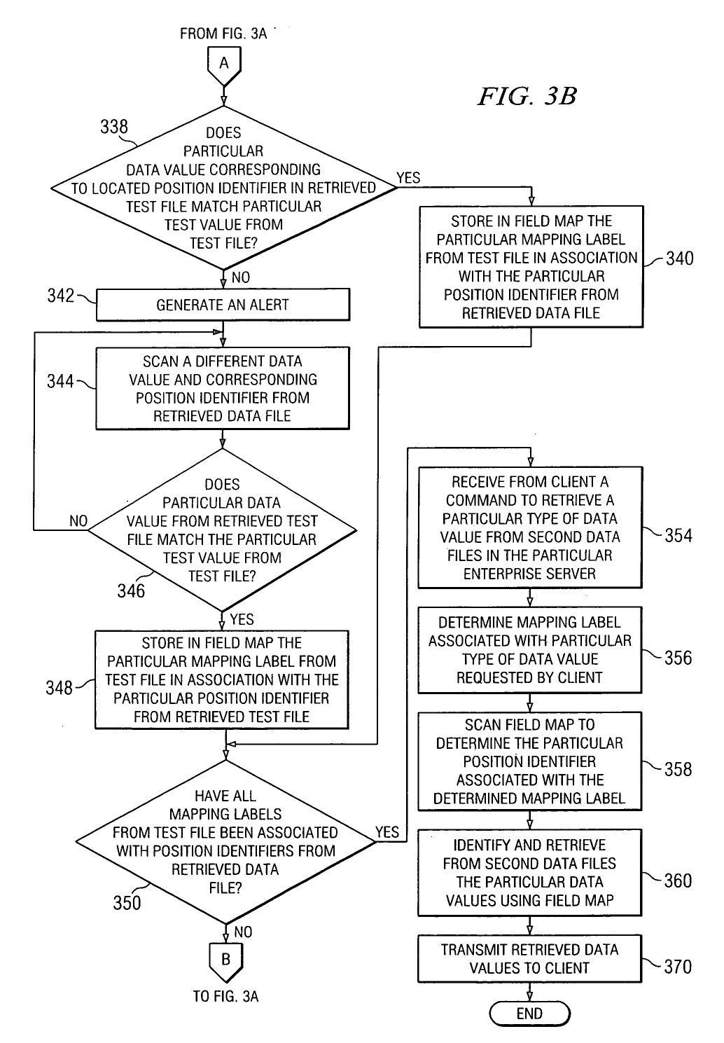

FIGS. 3A and 3B illustrate a flow chart for generating field map 48 according to one embodiment of the present invention. The method begins at step 302 when processor 42 receives a command to generate field map 48 associated with a particular enterprise server 20. At step 304, processor 42 determines whether mapping memory 44 comprises test file 46 that is suitable to generate field map 48 associated with enterprise server 20. If at step 304, processor 42 determines that mapping memory 44 comprises a suitable test file 46, the method proceeds to step 310. However, if at step 304 processor 42 determines that mapping memory 44 does not comprise suitable test file 46, then at step 306 processor 42 generates test file 46. In test file 46, processor 42 associates a plurality of mapping labels 64 with a plurality of test values 62 at step 308. At step 310, processor 42 determines the type of the particular enterprise server 20 that will be mapped. At step 312, processor 42 determines and stores in test file 46 a plurality of expected position identifiers 72. Expected position identifiers 72 may be based at least in part on the type of the particular enterprise server 20. Each test value 62 in test file 46 may be associated with at least one expected position identifier 72.

At step 314, processor 42 directs enterprise server 20 to generate a new data record 27. At step 316, processor 42 scans from the new data record 27 a particular interface label 66. At step 318, processor 42 determines whether test file 46 comprises a particular mapping label 64 that corresponds to the scanned interface label 66. If at step 318 processor 42 determines that no mapping label 64 in test file 46 corresponds to the scanned interface label 66, then processor 42 leaves blank the scanned interface label 66 and proceeds to step 322. However, if at step 318 processor 42 identifies in test file 46 a particular mapping label 64 that corresponds to the scanned interface label 66, then at step 320 processor 42 retrieves from test file 46 the particular test value 62 that corresponds to the identified mapping label 64. At step 321, processor 42 and/or enterprise server 20 inputs the identified test value 62 into the data field associated with the scanned interface label 66 in the new data record 27.

At step 322, processor 42 determines whether it has scanned all interface labels 66 in the new data record 27. Alternatively, or in addition, processor 42 may determine whether it has input into the new data record 27 all test values 62 from test file 46. If at step 322 processor 42 determines that it has not scanned all interface labels 66 in the new data record 27 (or, in some embodiments, if processor 42 determines that it has not input all test values 62 from test file 46), then the process returns to step 316 where processor 42 scans from the new data record 27 the next interface label 66. If, however, at step 322 processor 42 determines that it has scanned all interface labels 66 in the new data record 27 (or, in some embodiments, if processor 42 determines that it has input all test values 62 from test file 46), then the method proceeds to step 324.

Although the foregoing steps are described as being performed by processor 42, it should be understood that all or a portion of these steps may be performed manually by an operator of mapping server 40 and/or console 30.

At step 324, enterprise server 20 stores the new data record 27 in enterprise server 20 that will be mapped. In doing so, the input data values 28 are stored in various positions in enterprise server 20. At step 326, processor 42 directs enterprise server 20 to retrieve the new data record 27 from database 26 in enterprise server 20. In retrieving the new data record 27, enterprise server 20 and/or processor 42 may, at step 328, determine position identifiers 68 associated with data values 28. Enterprise server 20 may transmit the retrieved new data record 27 and the determined position identifiers 68 to processor 42 as retrieved data record 50. At step 330, processor 42 may receive and store in mapping memory 44 retrieved test file 46.

At step 332, processor 42 begins generating field map 48 associated with the particular enterprise server 20. At step 334, processor 42 scans from test file 46 a particular test value 62 and the corresponding expected position identifier 72 and mapping label 64. At step 336, processor 42 locates in retrieved test file 46 a particular position identifier 68 that corresponds to expected position identifier 72. At step 338, processor 42 determines whether the particular data value 28 corresponding to the located position identifier 68 in retrieved test file 46 matches the particular test value 62 from test file 46. If at step 338, processor 42 determines that the particular test value 62 matches the particular data value 28, then at step 340, processor 42 stores in field map 48 the particular mapping label 64 from test file 46 in association with the particular position identifier 68 from retrieved data record 50.

If at step 338, processor 42 determines that the particular test value 62 does not match the particular data value 28, then at step 342 processor 42 generates an alert, such as for an operator and/or administrator of mapping server 40. At step 344, processor 42 scans a different data value 28 and associated position identifier 68 from retrieved data record 50. At step 346, processor 42 determines whether the particular data value 28 from retrieved test file 46 matches the particular test value 62 from test file 46. If at step 346, processor 42 determines that the particular test value 62 matches the particular data value 28, then at step 348, processor 42 stores in field map 48 the particular mapping label 64 from test file 46 in association with the particular position identifier 68 from retrieved test file 46. If at step 346, processor 42 determines that the particular test value 62 does not match the particular data value 28, then the method returns to step 344.

At step 350, processor 42 determines whether all mapping labels 64 from test file 46 have been associated with position identifiers 68 from retrieved data record 50. If at step 350, processor 42 determines that all mapping labels 64 from test file 46 have not been associated with position identifiers 68 from retrieved data record 50, then the method returns to step 334. However, if at step 352, processor 42 determines that all mapping labels 64 from test file 46 have been associated with position identifiers 68 from retrieved data record 50, then the method proceeds to step 354.

At step 354, processor 42 receives from client 70 a command to retrieve a particular type of data value 28 from one or more other data records 27 in the particular database 26. At step 356, processor 42 determines the particular mapping label 64 associated with the particular type of data value 28 requested by client 70. At step 358, processor 42 scans field map 48 to determine the particular position identifier 68 associated with the determined mapping label 64. At step 360, processor 42 identifies and retrieves from the one or more other data records 27 the particular data values 28 associated with the particular position identifier 68 determined from field map 48. At step 362, the retrieved data values 28 are transmitted to client 70.

In some embodiments of the present invention, interface labels 66 associated with a particular enterprise server 20 may not directly correlate to mapping labels 64 in test file 46. For example, a particular enterprise server 20 may store data records 27 related to car sale transactions. The particular enterprise server 20 may name a particular interface label 66 corresponding to the model of a car as “Series.” In test file 46, however, the particular mapping label 64 corresponding to the model of a car may be “Model.” When processor 42 inputs test values 62 into a new data record 27 in order to generate field map 48, it may be desirable to provide processor 42 with the means for recognizing that interface label 66 of “Series” in the new data record 27 is substantially equivalent to mapping label 64 of “Model” in test file 46. According to certain embodiments, database system 10 is operable to generate an alias file 54 that is usable by processor 42 to interpret interface labels 66 associated with enterprise server 20.

Referring briefly back to FIG. 1, mapping memory 44 may further comprise screen file 52 and alias file 54. Screen file 52 may be based at least in part on user interface 32. User interface 32 may be configured to present an operator with one or more screens for inputting data values 28 in order to create data record 27. Each screen may comprise one or more interface labels 66. Each interface label 66 may occupy a particular interface label position 74 on a screen of user interface 32. For example, on a particular screen of user interface 32, “Contract Date” may be displayed as the first field and “Customer Name” may be displayed as the second field.

Generally, processor 42 may use test file 46 and screen file 52 to generate alias file 54. Processor 42 may generally use alias file 54 to determine which mapping labels 64 in test file 46 correspond to which interface labels 66 associated with a particular enterprise server 20. Alias file 54 comprises a plurality of interface labels 66 and a plurality of mapping labels 64. In alias file 54, each mapping label 64 may be associated with one or more interface labels 66. Processor 42 may generate alias file 54 by executing alias logic 58 stored in mapping memory 44. Alias logic 58 may comprise any suitable number and combination of tables, algorithms, functions, formulas, and/or instructions suitable for identifying one or more correlations between a particular mapping label 64 and a particular interface label 66.

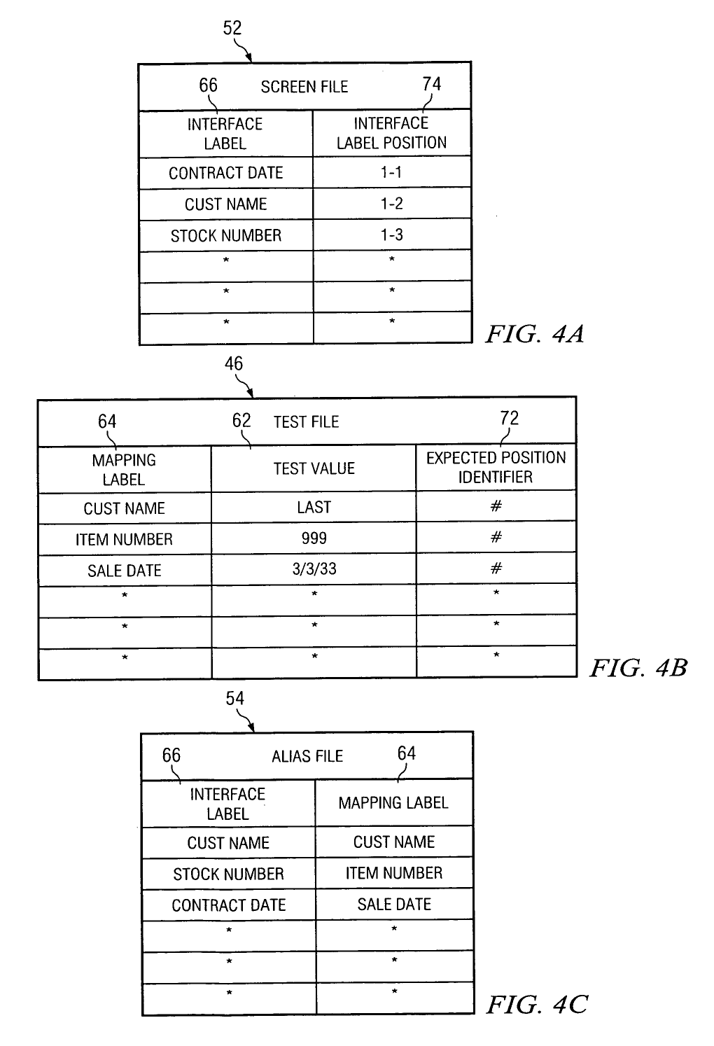

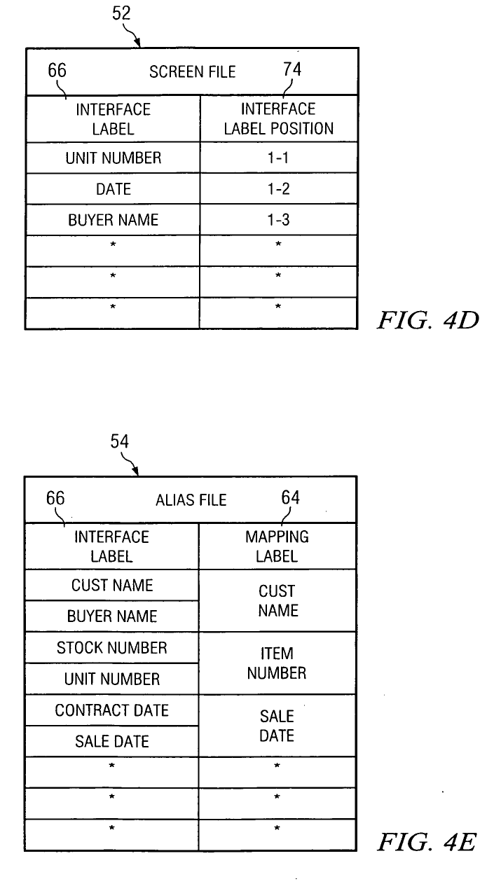

FIGS. 4A-4E illustrates test file 46, screen files 52, and alias files 54 according to certain embodiments of the present invention. To generate alias file 54, processor 42 may scan each interface label 66 and determine each interface label position 74 from each screen of user interface 32. As illustrated in FIG. 4A, processor 42 may store in screen file 52 each scanned interface label 66 in association with the corresponding interface label position 74. For example, if the first interface label 66 displayed on the first screen of user interface 32 is “Contract Date”, then processor 42 may store “Contract Date” in screen file 52 in association with “1-1”. The entry “1-1” may represent interface label position 74 corresponding to field one of screen one. The process of scanning interface labels 66 and interface label positions 74 from screens of user interface 32 may be referred to as a “screen scrape.” Processor 42 “scrapes” or scans interface labels 66 from screens of user interface 32 to generate screen file 52. Screen file 52 may be stored in mapping memory 44.

It will be understood that interface label position 74 may be represented by any number and combination of suitable identifiers. It will be further understood that there may be any number and combination of screens and interface labels 66 associated with a particular data record 27 in database 26.

Once processor 42 has generated screen file 52, processor 42 may use screen file 52 and test file 46 to begin generating alias file 54 for the particular database 26. In particular, processor 42 may scan from test file 46, illustrated in FIG. 4B, a particular mapping label 64. Processor 42 may then scan screen file 52 to determine whether a particular interface label 66 matches the particular mapping label 64 from test file 46. If processor 42 determines that a particular interface label 66 in screen file 52 matches the particular mapping label 64, then processor 42 may store in alias file 54 the particular mapping label 64 and the particular interface label 66. However, if processor 42 determines that no interface label 66 in screen file 52 matches the particular mapping label 64 from test file 46, then processor 42 may execute alias logic 58 to determine whether screen file 52 comprises an interface label 66 that correlates to the particular mapping label 64. For example, in an enterprise server 20 with a database 26 related to car sales, a particular interface label 66 may be “Contract Date.” “Contract Date” may refer to the date of the sales agreement for a car. In the present example, test file 46 may be configured to comprise a mapping label 64 of “Sales Date” for the date of the sales agreement for a car. Because the interface label 66 of “Contract Date” is different than the mapping label 64 of “Sales Date”, processor 42 may use alias logic 58 to determine whether “Sales Date” and “Contract Date” are associated with the same type of data value 28.

In the present example, by executing logic, algorithms, tables, and/or functions stored in alias logic 58, processor 42 may determine that, with respect to the particular database 26, “Sales Date” and “Contract Date” both refer to the same type of data (i.e., date of the sales agreement). Upon making this determination, processor 42 may store in alias file 54 the mapping label 64 of “Sales Date” in association with the interface label 66 of “Contract Date”. Processor 42 repeats the foregoing process for each mapping label 64 from test file 46. Thus, as illustrated in FIG. 4C, processor 42 generates an alias file 54 that correlates each mapping label 64 from test file 46 with a particular interface label 66 from user interface 32.

Processor 42 is operable to use alias file 54 to automatically input test values 62 into user interface 32. Because alias file 54 correlates interface labels 66 with mapping labels 64, processor 42 may automatically input test values 62 even when user interface 32 uses names for a particular type of data value 28 that are different than the names in test file 46. By automating the input of test values 62 in such situations, database system 10 may decrease the time and/or resources required for mapping databases 26 and, consequently, for extracting data values 28 from databases 26.

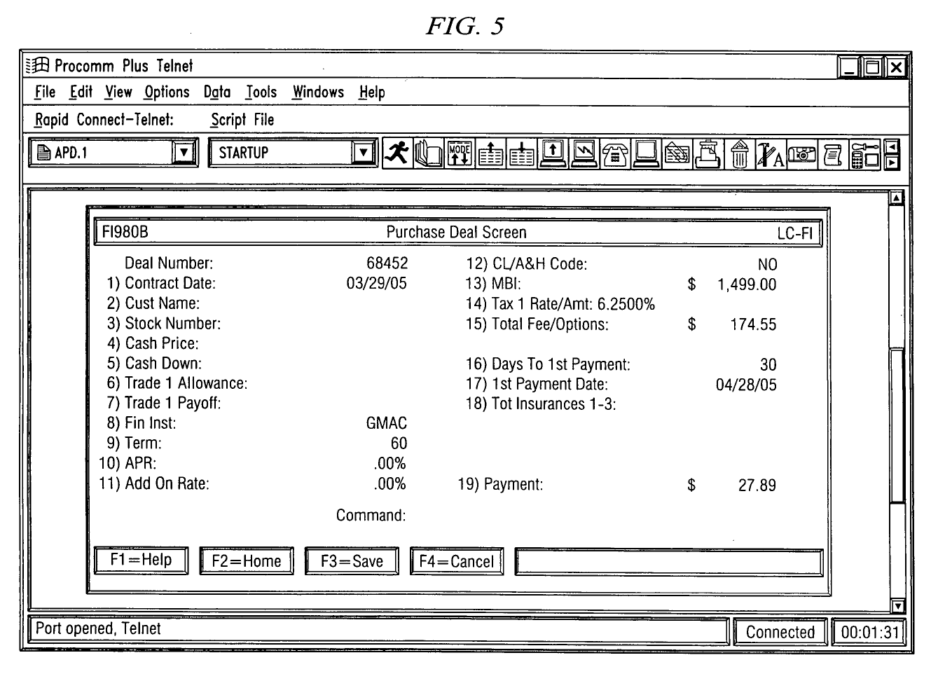

An example illustrates certain embodiments of the present invention. It should be noted that FIGS. 4A-C illustrates screen file 52, test file 46, and alias file 54 according to the present example. It should also be noted that FIG. 5 illustrates an example screen of user interface 32 according to the present example. In the present example, mapping memory 44 comprises test file 46. Test file 46 comprises a plurality of mapping labels 64 including “Cust Name”, “Item Number”, and “Sale Date”. Each mapping label 64 in test file 46 is associated with a particular test value 62. In the present example, processor 42 receives a command to generate field map 48 corresponding to a first enterprise server 20. As a result, processor 42 commences the process of “screen scraping” the user interface 32 associated with the enterprise server 20 in order to generate screen file 52. In the present example, the first screen of user interface 32 comprises a plurality of interface labels 66. The first interface label 66 on user interface 32 is “Contract Date”, the second interface label 66 is “Cust Name”, and the third interface label 66 is “Stock Number”. Processor 42 scans each interface label 66 and position 74. In the present example, because “Contract Date” is the first interface label 66 on the first screen, processor 42 is configured to designate “1-1” as the interface label position 74 associated with “Contract Date.” The second interface label 66 on the first screen is assigned “1-2” as interface label position 74, and so forth. Processor 42 stores each interface label 66 and position 74 in screen file 52.

In the present example, once processor 42 stores screen file 52 in mapping memory 44, processor 42 commences to generate alias file 54. Processor 42 scans from test file 46 the first mapping label 64, which in this example is “Cust Name.” Processor 42 then scans screen file 52 to determine whether a particular interface label 66 matches “Cust Name.” In the present example, screen file 52 also comprises “Cust Name.” Thus, processor 42 identifies the match and stores in alias file 54 the mapping label 64 of “Cust Name” and the interface label 66 of “Cust Name”. Processor 42 then scans from test file 46 the second mapping label 64, which in this example is “Item Number.” Processor 42 scans screen file 52 to determine whether a particular interface label 66 matches “Item Number.” In the present example, processor 42 determines that no interface label 66 in screen file 52 matches “Item Number.” As a result, processor 42 executes alias logic 58 to determine whether screen file 52 comprises an interface label 66 that correlates to “Item Number.” In the present example, processor 42 determines that interface label 66 of “Stock Number” relates to the item number of the product that was sold. Accordingly, processor 42 determines that “Stock Number” and “Item Number” relate to the same type of data value 28 (i.e., item number of a product). Upon making this determination, processor 42 stores in alias file 54 the mapping label 64 of “Item Number” in association with the interface label 66 of “Stock Number.” By repeating the foregoing process, processor 42 determines that interface label 66 of “Contract Date” correlates to mapping label 64 of “Sales Date.” As a result, processor 42 associates “Contract Date” with “Sales Date” in alias file 54. Processor 42 repeats the foregoing process for each mapping label 64 from test file 46.

The foregoing example illustrates a particular database 26 related to sales transactions. It should be understood, however, that database 26 may relate to any suitable information and/or endeavor. It should be further understood that test file 46 may comprise any number and combination of test values 62.

In some embodiments, mapping server 40 may use alias file 54 to generate field maps 48 for multiple enterprise servers 20. In such embodiments, alias file 54 may comprise a plurality of interface labels 66 and a plurality of mapping labels 64. In certain embodiments, alias file 54 may not comprise interface label positions 74. Each time mapping server 40 generates field map 48 for a particular enterprise server 20, mapping server 40 may supplement the list of interface labels 66 in alias file 54. Mapping server 40 may also supplement the relationships between mapping labels 64 and interface labels 66 in alias file 54.

An example illustrates certain embodiments of the present invention. In the present example, mapping server 40 already generated alias file 54 (illustrated in FIG. 4C) in order to generate field map 48 for a first enterprise server 20. Subsequently, mapping server 40 receives a command to generate field map 48 for a second enterprise server 20. As a result, processor 42 commences the process of “screen scraping” the user interface 32 associated with the second enterprise server 20 in order to generate screen file 52. In the present example, the first screen of user interface 32 associated with second enterprise server 20 comprises a plurality of interface labels 66. The first interface label 66 is “Unit Number”, the second interface label 66 is “Date”, and the third interface label 66 is “Buyer Name”. Processor 42 scans each interface label 66 and position 74. As illustrated in FIG. 4D, processor 42 stores each interface label 66 and position 74 in screen file 52.

In the present example, once processor 42 generates screen file 52 associated with the second enterprise server 20, processor 42 attempts to correlate interface labels 66 in screen file 52 to mapping labels 64 in alias file 54. In the present example, alias file 54 already comprises mapping labels 64 associated with interface labels 66 based on the first enterprise server 20. Accordingly, processor 42 reads the first interface label 66 of “Unit Number” from screen file 52. Processor 42 then scans interface labels 66 in alias file 54 to determine whether a particular interface label 66 already stored in alias file 54 matches “Unit Number”. In the present example, no interface labels 66 in alias file 54 match “Unit Number”. Accordingly, processor 42 executes alias logic 58 to determine whether alias file 54 comprises a mapping label 64 that correlates to “Unit Number”. In the present example, processor 42 determines that mapping label 64 of “Item Number” correlates to “Unit Number”. Upon making this determination, processor 42 stores in alias file 54 the interface label 66 of “Buyer Name” in association with the mapping label 64 of “Cust Name”, as illustrated in FIG. 4E. As a result, in alias file 54, mapping label 64 of “Item Number” is now associated with two interface labels 66—“Stock Number” and “Unit Number”. Using test file 46 illustrated in FIG. 4B, processor 42 then identifies test value 62 associated with “Item Number” (i.e., “999”). Processor identifies in screen file 52 interface label position 74 of “1-1” associated with “Unit Number”. Processor 42 then inputs “999” into the new data record 27 at interface label position 74 of “1-1”.

Processor 42 repeats the foregoing process for each interface label 66 in screen file 52 for second enterprise server 20. In doing so, processor 42 stores in alias file 54 interface label 66 of “Date” in association with mapping label 64 of “Sale Date”. Consequently, in alias file 54 mapping label 64 of “Sale Date” is associated with two interface labels 66—“Contract Date” and “Date”. Processor 42 also stores in alias file 54 interface label 66 of “Buyer Name” in association with mapping label 64 of “Cust Name”. Consequently, in alias file 54 mapping label 64 of “Cust Name” is associated with two interface labels 66—“Cust Name” and “Buyer Name”. Thus, each time mapping server 40 generates test file 46 for a particular enterprise server 20, mapping server 40 is operable to supplement in alias file 54 the associations between interface labels 66 and mapping labels 64. Thus, alias file 54 may become more robust over time.

In some embodiments, database system 10 may use a subject matter expert instead or, or in addition to, alias logic 58. In particular, for the determination of whether a particular mapping label 64 relates to the same type of data value 28 as a particular interface label 66 that is different from mapping label 64, database system 10 may use a subject matter expert. If processor 42 determines that no interface label 66 in screen file 52 matches the particular mapping label 64 from test file 46, then database system 10 may transmit an alert associated with the mapping label 64 and/or screen file 52 to the subject matter expert. The subject matter expert may review the particular mapping label 64 and one or more interface labels 66 from screen file 52. Based on the expert's experience, knowledge, intuition, and/or expertise, the expert may determine whether mapping label 64 relates to the same type of data value 28 as a particular interface label 66 in screen file 52.

It should be understood that, in some embodiments, the functionality of scanning interface labels 66 and generating alias file 54 may be performed by processor 42 in mapping server 40. In other embodiments, mapping server 40 may direct that enterprise server 20 perform all or part of this functionality.

In some embodiments, an enterprise 12 may occasionally update and/or modify a particular enterprise server 20. For example, an operator may change a particular interface label 66 in user interface 32. Such changes may occur when an enterprise 12 hires a new operator to manage enterprise server 20. The new operator may change one or more interface labels 66 (e.g., “Interest Rate” to “APR”, “Cash Down” to “Down Payment”, etc.) to resemble interface labels 66 with which the new operator is familiar. Such changes to enterprise server 20 may prompt database system 10 to update alias file 54 and/or field map 48 associated with that database 26. In some embodiments, database system 10 may determine to update alias file 54 and/or field map 48 because the new operator notifies database system 10 of the changes to the particular database 26. In other embodiments, database system 10 may determine that changes have been made to the particular database 26 by detecting errors that arise during extraction and/or insertion of data values 28 from and/or to the particular database 26.

Upon determining that a particular database 26 has been changed, database system 10 may repeat the process described above with respect to FIG. 2 in order to update field map 48 associated with the particular database 26. In some embodiments, database system 10 may create a new field map 48 to replace the prior field map 48. In other embodiments, database system 10 may update the original field map 48 by applying to the original field map 48 any changes uncovered by the mapping process.

Upon determining that a particular database 26 has been changed, database system 10 may, additionally or alternatively, repeat the process described above with respect to FIGS. 4A-4E in order to update alias file 54. In particular, processor 42 may perform another screen scrape of user interface 32 to generate an updated screen file 52. Based at least in part on the updated screen file 52, processor 42 may generate a new alias file 54 and/or simply apply to the original alias file 54 any suitable changes.

Database system 10 may provide several important technical advantages. Various embodiments of database system 10 may have none, some, or all of these advantages. One advantage is that database system 10 is operable to generate a particular alias file 54 for each type of enterprise server 20 in database system 10. Alias file 54 may correlate mapping labels 64 from test file 46 with interface labels 66 and positions 74 associated with user interface 32 of a particular enterprise server 20. Alias file 54 may enable mapping server 40 to automatically input into user interface 32 test values 62. Thus, database system 10 may reduce the time and/or resources required to generate field map 48 associated with a particular enterprise server 20. Consequently, database system 10 may reduce the time and/or resources required to extract data values 28 from enterprise servers 20 in database system 10.

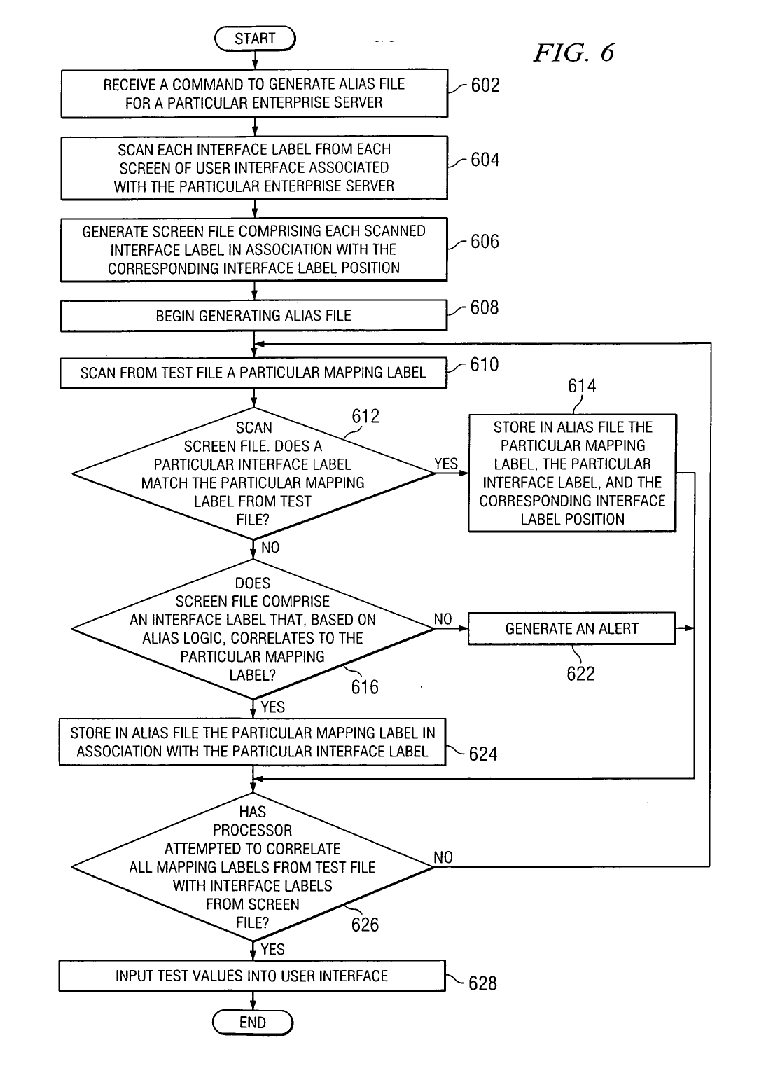

FIG. 6 illustrates a flow chart for generating alias file 54 according to one embodiment of the present invention. The method begins at step 602 when processor 42 receives a command to generate alias file 54 for a particular enterprise server 20. At step 604, processor 42 scans each interface label 66 from each screen of user interface 32 associated with the particular enterprise server 20. At step 606, processor 42 generates screen file 52 comprising each scanned interface label 66 in association with the corresponding interface label position 74.

At step 608, processor 42 uses screen file 52 and test file 46 to begin generating alias file 54 for the particular enterprise server. At step 610, processor 42 scans from test file 46 a particular mapping label 64. At step 612, processor 42 scans screen file 52 to determine whether a particular interface label 66 matches the particular mapping label 64 from test file 46. If at step 612 processor 42 determines that a particular interface label 66 in screen file 52 matches the particular mapping label 64, then at step 614 processor 42 stores in alias file 54 the particular mapping label 64 and the particular interface label 66. However, if at step 612 processor 42 determines that no interface label 66 in screen file 52 matches the particular mapping label 64 from test file 46, then at step 616 processor 42 executes alias logic 58 to determine whether screen file 52 comprises an interface label 66 that correlates to the particular mapping label 64. If at step 616 processor 42 determines that screen file 52 does not comprise an interface label 66 that correlates to the particular mapping label 64, then at step 622 processor 42 may generate an alert to signify that mapping label 64 does not correspond to any interface labels 66 in screen file 52. The method may then proceed to step 626.

If at step 616 processor 42 determines that screen file 52 comprises an interface label 66 that correlates to the particular mapping label 64, than at step 624 may store in alias file 54 the particular mapping label 64 in association with the particular interface label 66. At step 626, processor 42 may determine whether it has attempted to correlate all mapping labels 64 from test file 46 with interface labels 66 from screen file 52. If at step 626 processor 42 determines that it has not attempted to correlate all mapping labels 64 from test file 46, then the method returns to step 610. However, if at step 626 processor 42 determines that it has attempted to correlate all mapping labels 64 from test file 46, then at step 628 processor 42 use alias file 54 to automatically input test values 62 into user interface 32. In some embodiments, step 628 may lead into step 318 of the flow chart illustrated in FIG. 3A. Thus, database system 10 may use alias file 54 to reduce the time and/or resources required for extracting data values 28 from databases 26.

Although the present invention has been described in detail, it should be understood the various changes, substitutions, and alterations can be made hereto without departing from the scope of the invention as defined by the appended claims.

What is claimed is:

1. A method for managing a database, comprising:
a) receiving a data record comprising a plurality of interface labels;
b) identifying in the data record a particular interface label and an associated label position;
c) storing the identified interface label and the associated label position in a first file;
d) scanning from the first file a particular interface label;
e) determining a mapping label that corresponds to the scanned interface label;
f) associating in a second file the determined mapping label with the scanned interface label;
g) identifying a test value associated with the determined mapping label; and
h) inputting the test value into the data record, wherein the test value is input according to the identified label position.

2. The method of claim 1, further comprising repeating steps (b) and (c) for at least a portion of the interface labels in the data record.

3. The method of claim 1, further comprising repeating steps (d) through (h) for a plurality of mapping labels.

4. The method of claim 1, further comprising:
i) storing the data record in a database;
j) retrieving from the database the data record, wherein the retrieved data record comprises at least one test value associated with at least one position identifier;
k) determining a mapping label associated with the at least one test value; and
l) storing in a field map the determined mapping label in association with the at least one position identifier.

5. The method of claim 4, wherein the retrieved data record comprises a plurality of test values associated with a plurality of position identifiers, and further comprising repeating steps (k) and (l) for at least a portion of the test values in the retrieved data record.

6. The method of claim 4, wherein the database comprises a second data record, and further comprising identifying a data value in the second data record, the identification based at least in part on the field map.

7. The method of claim 1, wherein the database represents a multi-value database.

8. A system for managing a database, comprising:
a memory operable to store a data record; and
a processor communicatively coupled to the memory and operable to:
a) receive a data record comprising a plurality of interface labels;
b) identify in the data record a particular interface label and an associated label position;
c) store the identified interface label and the associated label position in a first file;
d) scan from the first file a particular interface label;
e) determine a mapping label that corresponds to the scanned interface label;
f) associate in a second file the determined mapping label with the scanned interface label;
g) identify a test value associated with the determined mapping label; and
h) input the test value into the data record, wherein the test value is input according to the identified label position.

9. The system of claim 8, wherein the processor is further operable to repeat steps (b) and (c) for at least a portion of the interface labels in the data record.

10. The system of claim 8, wherein the processor is further operable to repeat steps (d) through (h) for a plurality of mapping labels.

11. The system of claim 8, wherein the processor is further operable to:
i) store the data record in a database;
j) retrieve from the database the data record, wherein the retrieved data record comprises at least one test value associated with at least one position identifier;
k) determine a mapping label associated with the at least one test value; and
l) store in a field map the determined mapping label in association with the at least one position identifier.

12. The system of claim 11, wherein:
the retrieved data record comprises a plurality of test values associated with a plurality of position identifiers; and
the processor is further operable to repeat steps (k) and (l) for at least a portion of the test values in the retrieved data record.

13. The system of claim 8, wherein:
the database comprises a second data record; and
the processor is further operable to identify a data value in the second data record, the identification based at least in part on the field map.

14. The system of claim 8, wherein the database represents a multi-value database.

15. Logic for managing a database, the logic encoded in computer-readable media and operable when executed to:
a) receive a data record comprising a plurality of interface labels;
b) identify in the data record a particular interface label and an associated label position;
c) store the identified interface label and the associated label position in a first file;
d) scan from the first file a particular interface label;
e) determine a mapping label that corresponds to the scanned interface label;
f) associate in a second file the determined mapping label with the scanned interface label;
g) identify a test value associated with the determined mapping label; and
h) input the test value into the data record, wherein the test value is input according to the identified label position.

16. The logic of claim 15, wherein the logic is further operable when executed to:
repeat steps (b) and (c) for at least a portion of the interface labels in the data record; and
repeat steps (d) through (h) for a plurality of mapping labels.

17. The logic of claim 15, wherein the logic is further operable when executed to:
i) store the data record in a database;
j) retrieve from the database the data record, wherein the retrieved data record comprises at least one test value associated with at least one position identifier;
k) determine a mapping label associated with the at least one test value; and
l) store in a field map the determined mapping label in association with the at least one position identifier.

18. The logic of claim 17, wherein:
the retrieved data record comprises a plurality of test values associated with a plurality of position identifiers; and
the logic is further operable when executed to repeat steps (k) and (l) for at least a portion of the test values in the retrieved data record.

19. The logic of claim 15, wherein:
the database comprises a second data record; and
the logic is further operable when executed to identify a data value in the second data record, the identification based at least in part on the field map.

20. The logic of claim 15, wherein the database represents a multi-value database.

21. A method for managing a database, comprising:
receiving a data record comprising a plurality of interface labels;
identifying in the data record a particular interface label and an associated label position;
determining a mapping label that corresponds to the identified interface label;
associating in an alias file the determined mapping label with the identified interface label;
identifying a test value associated with the determined mapping label; and
inputting the test value into the data record, wherein the test value is input according to the identified label position.

22. A method for managing a database, comprising:
identifying a test value associated with a mapping label, the mapping label corresponding to a label position;
inputting the test value into a data record, wherein the test value is input according to the label position;
storing the data record in a database;
retrieving from the database the data record, wherein the retrieved data record comprises the test value associated with a position identifier; and
storing in a field map the mapping label in association with the position identifier.
